(19) United States
(12) Patent Application Publication
(10) Pub. No.: US 2019/0018528 A1
(43) Pub. Date: Jan. 17, 2019

(54) DISPLAY DEVICE

(71) Applicant: Japan Display Inc., Minato-ku (JP)

(72) Inventor: TOSHIYUKI HIGANO, Tokyo (JP)

(73) Assignee: Japan Display Inc., Minato-ku (JP)

(21) Appl. No.: 16/018,378

(22) Filed: Jun. 26, 2018

(30) Foreign Application Priority Data
Jul. 11, 2017 (JP) 2017-135793

(51) Int. Cl. G06F 3/041; G02F 1/1335; G02F 1/1337; G02F 1/1333; G06F 3/047; G02F 1/1362; G02F 1/1343; G02F 1/1345

(52) U.S. Cl. CPC G06F 3/0412; G02F 1/133514; G02F 1/133512; G02F 1/1337; G02F 1/13338; G02F 2201/121; G02F 1/136286; G02F 1/134309; G02F 1/133305; G02F 1/13452; G02F 2201/123; G06F 3/047

(57) ABSTRACT

According to one embodiment, a display device includes a flexible substrate and first mounting terminals. The flexible substrate has an end area including a side and a drive area. The first mounting terminals are arranged in a first direction. A first external circuit board is mounted on the first mounting terminals. The drive area has first and second areas. The first area includes the first mounting terminals. The second area is located between the first area and the side. The first mounting terminals extend in a second direction. The second area is longer than the first area in the second direction.

### CROSS-REFERENCE TO RELATED APPLICATIONS

This application is based upon and claims the benefit of priority from Japanese Patent Application No. 2017-135793, filed Jul. 11, 2017, the entire contents of which are incorporated herein by reference.

### FIELD

Embodiments described herein relate generally to a flexible display device.

### BACKGROUND

Flexible display devices comprise flexible substrates formed of polyimide resin, etc. A flexible substrate is applied and hardened on a support substrate formed of glass or quartz, and then the flexible substrate is removed from the support substrate by applying laser light to the interface. When laser light is applied to the flexible substrate via the light transmissive support substrate, the interface of the flexible substrate is slightly resolved, and a space is made between the flexible substrate and the support substrate.

Laser light tends to be reflected off the sides (fracture surfaces) of the support substrate more irregularly as compared to the flat main surfaces of the support substrate. Therefore, the flexible substrate may remain attached to portions near the sides of the support substrate. In this case, the few remaining attached portions are mechanically removed by external force. At that time, damage such as cracks may be caused on the sides of the flexible substrate. If the damaged position is close to mounting terminals, the connection reliability of an external circuit board mounted on the mounting terminals will be affected.

Meanwhile, a flexible substrate can be downsized in a plane view by bending ends thereof. By making use of the characteristics, some consider increasing an end area and forming more wiring lines and circuits than those of a conventional product in the end area.

### BRIEF DESCRIPTION OF THE DRAWINGS

FIG. 1 is a plan view schematically showing the structure of a display device of the first embodiment.

FIG. 2 is a sectional view schematically showing the structure of the display device in a display area shown in FIG. 1.

FIG. 3 is a flowchart showing an example of a manufacturing method of the display device shown in FIG. 1.

FIG. 4 is an enlarged plan view of a drive area shown in FIG. 1.

FIG. 5 is a sectional view showing a second area in a bended state.

FIG. 6 is a sectional view showing an example of a display device of the second embodiment.

FIG. 7 is a sectional view showing another example of the display device of the second embodiment.

FIG. 8 is a sectional view showing an example of a display device of the third embodiment.

FIG. 9 is a sectional view showing another example of the display device of the third embodiment.

FIG. 10 is a perspective view showing an example of a display device of a fourth embodiment.

FIG. 11 is a perspective view showing another example of the display device of the fourth embodiment.

FIG. 12 is a perspective view showing an example of a display device of a fifth embodiment.

### DETAILED DESCRIPTION

In general, according to one embodiment, a display device includes a flexible substrate and a plurality of first mounting terminals. The flexible substrate has an end area including a side and a drive area. The first mounting terminals are arranged in a first direction. A first external circuit board is mounted on the first mounting terminals. The drive area has a first area and a second area. The first area includes the first mounting terminals. The second area is located between the first area and the side of the flexible substrate. The first mounting terminals extend in a second direction intersecting the first direction. The second area which does not include the first mounting terminals is longer than the first area which includes the first mounting terminals in the second direction.

According to the structure of the display device, the connection reliability of the mounting terminals and the external circuit board can be ensured without being affected by damage caused in the end area of the flexible substrate. Further, by increasing the end area of the flexible substrate, other circuits and wiring lines, etc., can be further formed in the end area of the flexible substrate.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings are presented schematically, rather than as an accurate representation of what is implemented. However, such schematic illustration is merely exemplary and in no way restricts the interpretation of the invention. In the drawings, reference numbers of continuously arranged elements equivalent or similar to each other are omitted in some cases. In addition, in the specification and drawings, structural elements equivalent or similar to those described in connection with preceding drawings are denoted by the same reference numbers, and detailed description thereof is omitted unless necessary.

In the specification, expressions such as “α includes A, B or C”, “a includes any one of A, B and C” and “α includes one selected from a group consisting of A, B and C” do not exclude a case where α includes various combinations of A, B and C unless otherwise specified. Further, these expressions do not exclude a case where α includes other elements.

In the specification, “the first, the second and the third” in an expression such as “the first α, the second α and the third α” simply represent numbers used for the sake of convenience of explaining elements. That is, an expression such as “A includes the third α” also includes a case where A does not include the first α and the second α unless otherwise specified.

In the following description, a display device DSP which is a liquid crystal display device will be disclosed as an example of the display device. However, the embodiments do not preclude the application of individual technical ideas disclosed in the embodiments to various other display devices. The main structures disclosed in the embodiments are applicable to a self-luminous display device such as an organic electroluminescent (EL) display device, an electronic-paper type display device having an electrophoresis element, etc., a display device adopting micro-electromechanical systems (MEMS), a display device adopting electrochromism, etc. The display device DSP can be used in various devices such as a smartphone, a tablet computer, a mobile phone, a personal computer, a television receiver, an in-car device, a game console and a wearable device.

### First Embodiment

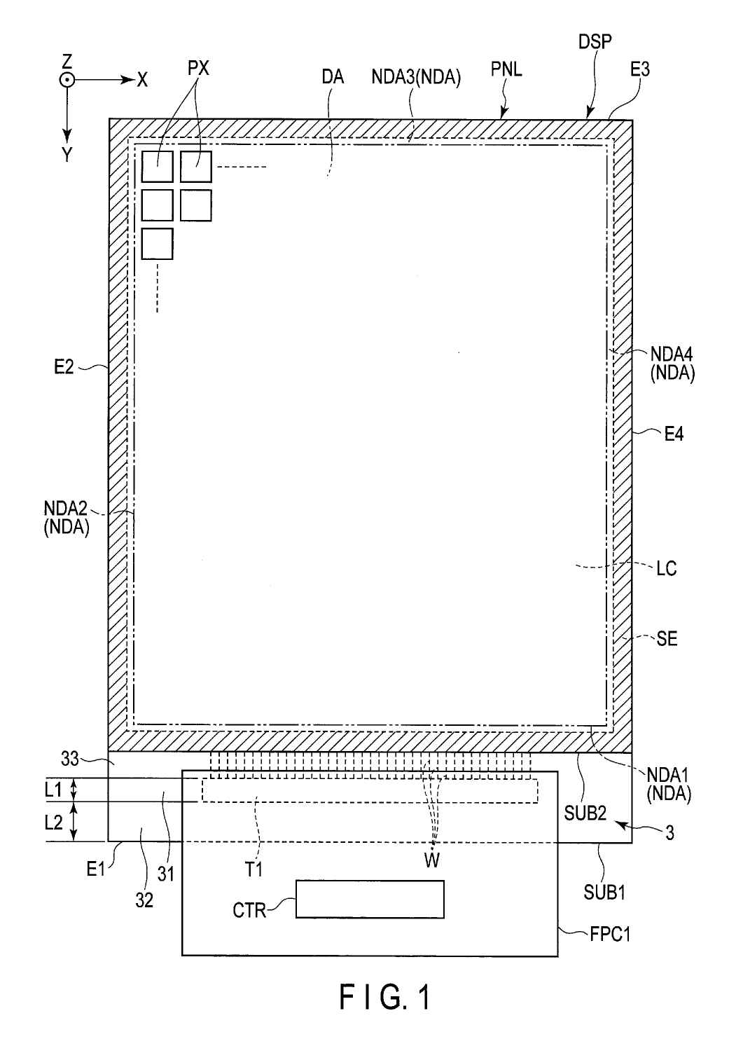

FIG. 1 is a plan view schematically showing the structure of the display device DSP of the first embodiment. The display device DSP includes a display panel (liquid crystal cell) PNL which displays an image on a display surface, and a first external circuit board FPC1 which is mounted on first mounting terminals T1 of the display panel PNL. In the following description, a view from the display surface to the rear surface of the display panel PNL is defined as a plane view.

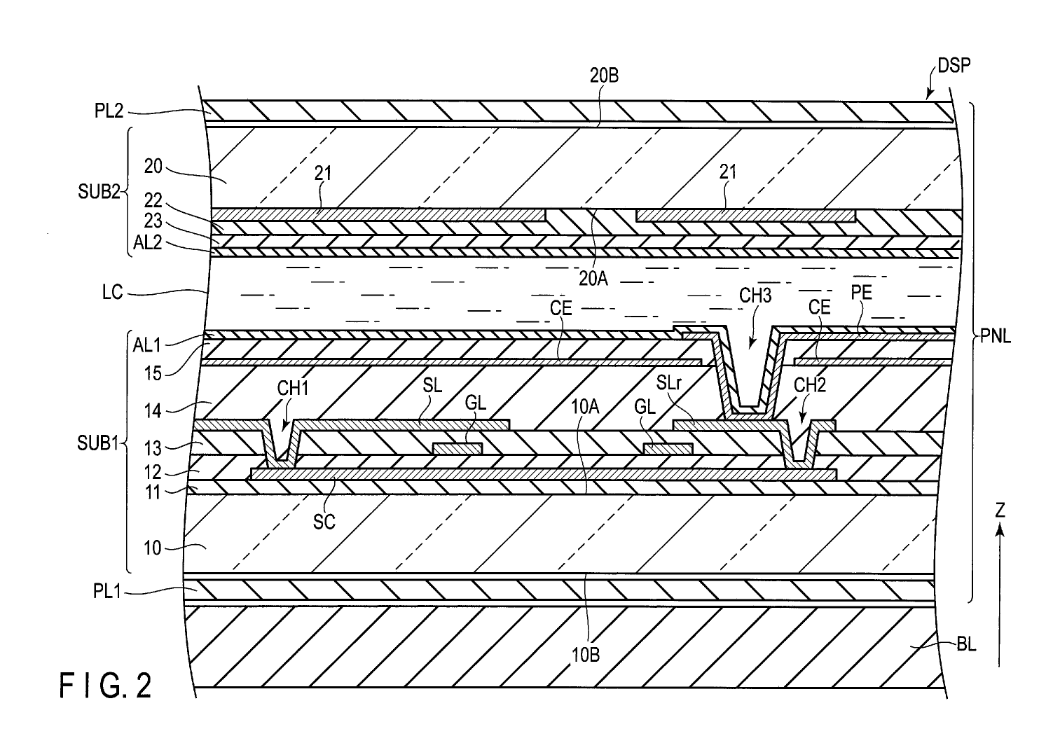

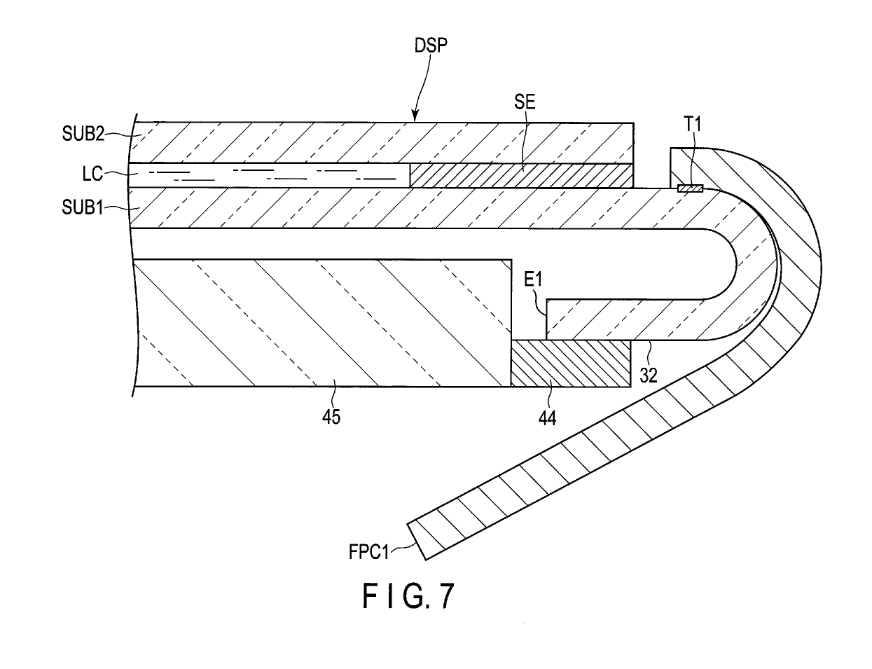

The display panel PNL may be a transmissive display panel which displays an image by selectively transmitting light from the rear surface or may be a reflective display panel which displays an image by selectively reflecting light entering the display surface. In the case of a transmissive display panel, an illuminator which emits light to the rear surface of the display panel PNL is further provided. The illuminator includes a backlight unit BL (shown in FIG. 2) and a light emitting element (electronic component 44 shown in FIG. 7). The first external circuit board FPC1 controls the operations of the display panel PNL and the illuminator.

The display panel PNL includes a flexible substrate (first substrate, array substrate) SUB1, a counter-substrate (second substrate) SUB2, a sealant (adhesive) SE and a liquid crystal layer LC. The flexible substrate SUB1 has a substantially rectangular shape having first to fourth sides E1, E2, E3 and E4. The counter-substrate SUB2 is opposed to the flexible substrate SUB1 in the thickness direction of the display panel PNL. The flexible substrate SUB1 is larger than the counter-substrate SUB2 and has a drive area 3 which is exposed from the counter-substrate SUB2.

The sealant SE corresponds to a portion shown by rising diagonal lines in FIG. 1 and attaches the flexible substrate SUB1 and the counter-substrate SUB2 together. On the inside of the sealant SE, the liquid crystal layer LC is arranged between the flexible substrate SUB1 and the counter-substrate SUB2. Light emitted from the illuminator passes through the flexible substrate SUB1 and enters the liquid crystal layer LC. The liquid crystal layer LC is an example of an electro-optical layer which is driven by electricity and selectively transmits light.

The display surface of the display panel PNL includes a display area DA in which a plurality of pixels PX are arranged in matrix, and a frame-like non-display area NDA which surrounds the display area DA on all sides. The display area DA overlaps most of the liquid crystal layer LC. The non-display area NDA overlaps the rest of the liquid crystal layer LC, the sealant SE and the drive area 3.

The non-display area NDA includes first to fourth non-display areas NDA1, NDA2, NDA3 and NDA4. The first non-display area NDA1 is located between the display area DA and the first side E1, the second non-display area NDA2 is located between the display area DA and the second side E2, the third non-display area NDA3 is located between the display area DA and the third side E3, and the fourth non-display area NDA4 is located between the display area DA and the fourth side E4.

The first non-display area NDA1 includes the drive area 3. That is, an end area of the flexible substrate SUB1 which includes the drive area 3 is the first non-display area NDA1. The first side E1 is the side in this end area. In the drive area 3, the flexible substrate SUB1 includes a plurality of wiring lines W and a plurality of first mounting terminals T1. The wiring lines W electrically connect various circuits formed in the non-display area NDA and the first mounting terminals T1. The first mounting terminals T1 are electrically connected to the first external circuit board FPC1 and receive various signals from the first external circuit board FPC1.

For example, a control module CTR is mounted on the first external circuit board FPC1. The control module CTR sequentially receives image data per frame for display in the display area DA from a main board, etc., of an electronic device on which the display device DSP is mounted. The image data includes, for example, information about the display color of each pixel PX, etc. The control module CTR supplies a signal for driving each pixel PX based on the received image data, to the display panel PNL.

FIG. 2 is a sectional view schematically showing the structure of the display device DSP in the display area DA. In the example shown in FIG. 2, the display device DSP has a structure conforming to a display mode which mainly uses a lateral electric field substantially parallel to the display surface. The display device DSP may have a structure conforming to a display mode which uses a longitudinal electric field perpendicular to the display surface, a structure conforming to a display mode which uses an oblique electric field inclined with respect to the display surface, or a structure conforming to a display mode which uses a combination thereof.

As shown in FIG. 2, the flexible substrate SUB1 includes a first flexible base 10, first to fifth insulating layers 11, 12, 13, 14 and 15, a semiconductor layer SC, a scanning signal line GL, a video signal line SL, a relay electrode SLr, a common electrode CE, a pixel electrode PE and a first alignment film AL1. The flexible substrate SUB1 can be curved since the flexible substrate SUB1 has the first flexible base 10 as a base.

The first flexible base 10 is formed of, for example, polyimide resin, etc., and is not only flexible but also light transmissive and insulating. The first flexible base 10 complies with JIS K 7361-1 (1997), and a haze value (opacity) measured by a haze meter is, for example, 10% or less, preferably, 5% or less, and more preferably, 2.5% or less. Examples of the haze meter are NDH 4000 (Nippon Denshoku Industries Co., Ltd.) and HZ-V3 (Suga Test Instruments Co., Ltd.).

The first flexible base 10 has a first surface 10A opposed to the counter-substrate SUB2, and a second surface 10B on the opposite side to the first surface 10A. The first insulating layer 11 covers the first surface 10A of the first flexible base 10. The semiconductor layer SC is formed on the first insulating film 11. The second insulating film 12 covers the first insulating film 11 and the semiconductor layer SC.

The scanning signal line GL is formed on the second insulating layer 12. The third insulating layer 13 covers the second insulating layer 12 and the scanning signal line GL. The video signal line SL and the relay electrode SLr are formed on the third insulating layer 13. The fourth insulating layer 14 covers the third insulating layer 13, the video signal line SL and the relay electrode SLr.

The common electrode CE is formed on the fourth insulating layer 14. The fifth insulating layer 15 covers the fourth insulating layer 14 and the common electrode CE. The pixel electrode PE is formed on the fifth insulating layer 15. The pixel electrode PE may be formed below the fifth insulating layer 15, and the common electrode CE may be formed on the fifth insulating layer 15. The first alignment film AL1 covers the fifth insulating layer 15 and the pixel electrode PE. First and second contact holes CH1 and CH2 penetrate the second and third insulating layers 12 and 13. A third contact hole CH3 penetrates the fourth and fifth insulating layers 14 and 15.

The video signal line SL contacts the semiconductor layer SC via the first contact hole CH1. The relay electrode SLr contacts the semiconductor layer SC via the second contact hole CH2. One of the video signal line SL and the relay electrode SLr is a source electrode and the other one of the video signal line SL and the relay electrode SLr is a drain electrode. The semiconductor SC, the source electrode and the drain electrode constitute a thin-film transistor (TFT).

The pixel electrode PE contacts the relay electrode SLr via the third contact hole CH3 and is electrically connected to the semiconductor layer SC. When voltage is applied to the pixel electrode PE via the source electrode, an electric field is formed between the pixel electrode PE and the common electrode CE, and the alignment of liquid crystal molecules of the liquid crystal layer LC is changed. Accordingly, the amount of light transmitted through the liquid crystal layer LC is controlled.

The counter-substrate SUB2 includes a second flexible base 20, a light-shielding layer 21, a color filter 22, an overcoat layer 23 and a second alignment film AL2. The color filter layer 22 may be formed in the flexible substrate SUB1. The second flexible base 20 is formed of the same resin material as that of the first flexible base 10. The counter-substrate SUB2 can be curved since the counter-substrate SUB2 has the second flexible base 20 as a base.

The second flexible base 20 has a third surface 30A opposed to the first surface 10A of the first flexible base 10, and a fourth surface 20B on the opposite side to the third surface 20A. The light-shielding layer 21 is formed on the third surface 20A of the second flexible base 20. The color filter layer 22 covers the third surface 20A and the light-shielding layer 21. The color filter layer 22 is colored in a color corresponding to a subpixel which constitutes a pixel PX. The overcoat layer 23 covers the color filter layer 22. The second alignment film AL2 covers the overcoat layer 23.

The liquid crystal layer LC is arranged between the first alignment film AL1 and the second alignment film AL2. The first and second alignment films AL1 and AL2 align the liquid crystal molecules of the liquid crystal layer LC in a state where voltage is not applied to the pixel electrode PE. A first polarizer PL1 is attached to the second surface 10B of the first flexible base 10. A second polarizer PL2 is attached to the fourth surface 20B of the second flexible base 20. In the case of using the backlight unit BL which emits polarized light, the first polarizer PL1 may be omitted.

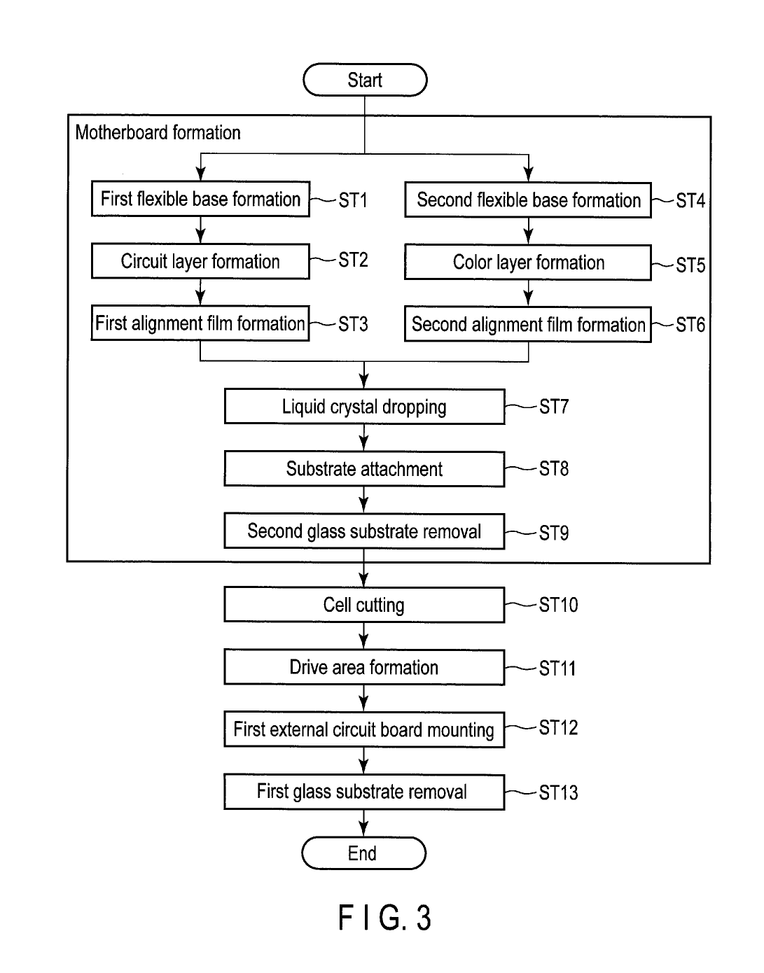

FIG. 3 is a flowchart showing an example of a manufacturing method of the display device DSP. The manufacturing method of the display device DSP includes a step of preparing the flexible substrate SUB1, a step of preparing the counter-substrate SUB2, and a step of attaching the flexible substrate SUB1 and the counter-substrate SUB2 and mounting the first external circuit board FPC1.

Steps ST1 to ST3 of preparing the flexible substrate SUB1 will be described. Firstly, the material of the first flexible base 10 is applied to the upper surface of a first glass substrate, and the applied material is hardened and the first flexible base 10 is formed (first flexible base formation ST1). For example, if a composition containing polyamide acid is applied to the first glass substrate and is imidized by thermal treatment at a temperature of 300 to 500° C., a polyimide film can be formed as the first flexible base 10.

A circuit layer having a layered structure of the scanning signal line GL, the video signal line SL, the semiconductor layer SC, the common electrode CE, the pixel electrode PE, the first to fifth insulating layers 11, 12, 13, 14 and 15, etc., is formed on the first flexible base 10 (circuit layer formation ST2). The material of the first alignment film AL1 is applied to the circuit layer, and the applied material is hardened and the first alignment film AL1 is formed (first alignment film formation ST3). A motherboard including the plurality of flexible substrates SUB1 is obtained through the steps ST1 to ST3.

Next, steps ST4 to ST6 of preparing the counter-substrate SUB2 will be described. Similarly to the step ST1, the second flexible base 20 is formed on a second glass substrate (second flexible base formation ST4). A color layer having a layered structure of the light-shielding layer 21, the color filter layer 22, the overcoat layer 23, etc., is formed on the second flexible base 20 (color layer formation ST5). Similarly to the step ST3, the second alignment film AL2 is formed on the color layer (second alignment film formation ST6). A motherboard including the plurality of counter-substrates SUB2 is obtained through the steps ST4 to ST6.

Next, steps ST7 to ST13 of attaching the flexible substrate SUB1 and the counter substrate SUB2 and mounting the first external circuit board FPC1 will be described. The material of the sealant SE is applied to one of the motherboards, and the liquid crystal material of the liquid crystal layer LC is dropped onto the area enclosed with the sealant SE (liquid crystal dropping ST7). The two motherboards are attached together, and the sealant SE is hardened (substrate attachment ST8). The method of injecting the liquid crystal layer LC is not limited to the steps ST7 and ST8 (one drop fill method). The flexible substrate SUB1 and the counter-substrate SUB2 may be attached together and then the liquid crystal layer LC may be sealed in by a vacuum injection method.

The second glass substrate is removed from the second flexible base 20 (second glass substrate removal ST9). As laser light is applied to the second flexible base 20 via the light transmissive second glass substrate, the second flexible base 20 absorbs the laser light and is slightly resolved. A space is made at the interface between the second flexible base 20 and the second glass substrate, and the second glass substrate is removed from the second flexible base 20 (laser lift off).

The motherboards including the flexible substrate SUB1 and the counter-substrate SUB2 together with the first glass substrate are cut into a plurality of panels (cell cutting ST10). A part of the counter-substrate SUB2 is cut out by laser light, and the first mounting terminals T1 of the flexible substrate SUB1 are exposed (drive area formation ST11). As a result, the drive area 3 is formed. The steps ST10 and ST11 may be integrated into one step.

The first external circuit board FPC1 is mounted on the exposed first mounting terminals T1 (first external circuit board mounting ST12). An anisotropic conductive film is arranged on the first mounting terminals T1. The anisotropic conductive film is a film adhesive containing uniformly-dispersed conductive particles. The first external circuit board FPC1 and the flexible substrate SUB1 are pressurized from above and below and are heated concurrently. A part of the anisotropic conductive film is molten, and the first external circuit board FPC1 and the flexible substrate SUB1 are electrically and mechanically connected to each other.

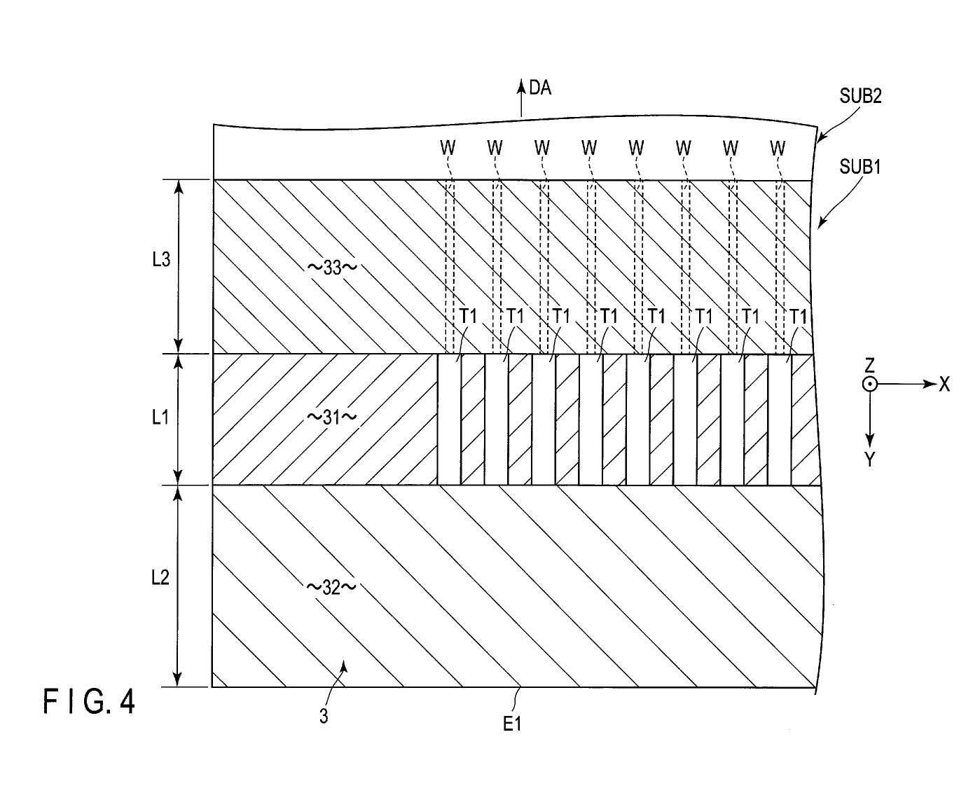

Similarly to the step ST9 of removing the second glass substrate, the first glass substrate is removed from the first flexible base 10 (first glass substrate removal ST13). At that time, damage such as cracks may be caused on the first to fourth sides E1, E2, E3 and E4 of the flexible substrate SUB1. Transparent polyimide resin used as the material of the flexible substrate SUB1 of the present embodiment has less polyimide skeletons and is less rigid as compared to nontransparent polyimide resin. That is, the first flexible base 10 formed of transparent polyimide resin tends to be damaged in the step ST13 more easily than the base formed of nontransparent polyimide resin. Therefore, in the present embodiment, even if a trouble is caused by the damage, the trouble can be prevented from spreading by providing a length L2 of a second area 32 of FIG. 4 which will be described later.

As the first and second polarizers Ph1 and PL2 are attached to the obtained panel and the backlight unit BL is integrated, the display device DSP is produced. The manufacturing method according to the present embodiment may further include a step of bending the first external circuit board FPC1 toward the rear surface of the display panel PNL after the step ST13. Further, the manufacturing method according to the present embodiment may further include a step of attaching the display panel PNL to a protective member (housing) such as a cover glass or may further include a step of curving the display surface of the display panel along the curved surfaces of the cover glass.

FIG. 4 is an enlarged plan view of the first mounting terminals T1. As shown in FIG. 4, the first mounting terminals T1 are arranged in a first direction X in the drive area 3. Each of the first mounting terminals T1 has the shape of, for example, a long and thin rectangle and extends in a second direction Y intersecting the first direction X. The shape of the first mounting terminals T1 is not limited to a rectangular shape and may be an elliptic shape, etc. The shape of the first mounting terminals T1 can be appropriately selected from various other shapes. In the example shown in FIG. 4, the first direction X is a direction along the first side E1 of the flexible substrate SUB1, and the second direction Y is a direction along the second side E2 of the flexible substrate SUB1. A third direction Z corresponding to the thickness direction of the display device DSP orthogonally intersects the first and second directions X and Y.

The drive area 3 includes first to third areas 31, 32 and 33 which are elongated in a strip-like manner in the first direction X. These areas are arranged in the second direction Y in the order of the second area 32, the first area 31 and the third area 33 from the first side E1 to the display area DA. The first mounting terminals T1 are arranged in the first area 31 sandwiched between the second area 32 and the third area 33. The third area 33 is located between the display area DA and the first area 31. The wiring lines W are arranged in the third area 33 and are connected to the corresponding first mounting terminals T1, respectively.

In the second direction Y, a length L1 of the first area 31 corresponds to the length of the first mounting terminals T1. A length L2 of the second area 32 is greater than the length L1 of the first area 31. In the example shown in FIG. 4, the length L2 of the second area 32 is greater than a length L3 of the third area 33. The first mounting terminals T1 are separated from the first side E1 at least by the length L2 of the second area 32, and even if damage is caused in the first side E1, the impact of the damage can be excluded.

The first external circuit board FPC1 is bended toward the rear surface side to be accommodated in the housing. The second area 32 can be bended toward the rear surface side and accommodated in the housing similarly to the first external circuit board FPC1. Instead of the first external circuit board FPC1 and the second area 32, the third area 33 may be bended by extending the length 3L.

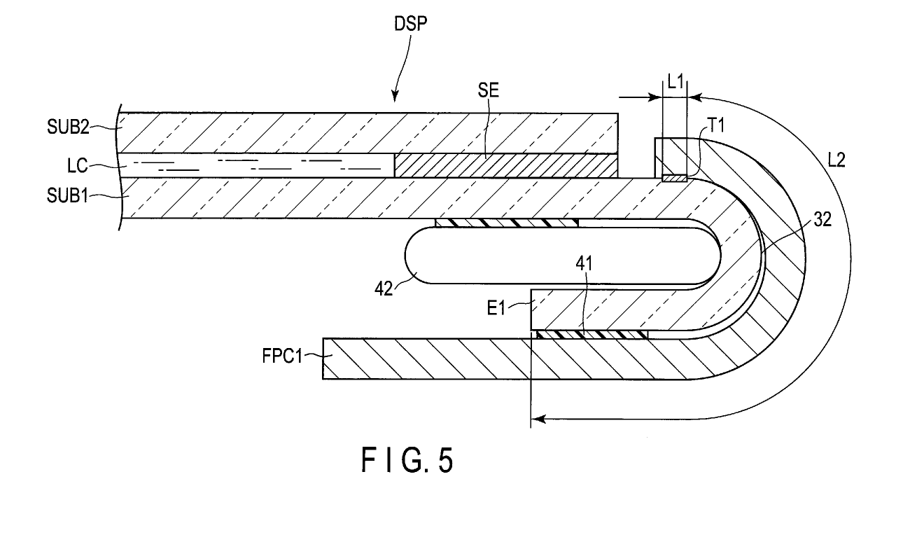

FIG. 5 is a sectional view showing the second area 32 in a bended state. When the second area 32 is curved, the length L2 is a length along the curved surface of the second area 32. In the example shown in FIG. 5, the second area 32 is fixed to the first external circuit board FPC1 via a fixing member 41 such as an adhesive or double-faced tape provided near the first side E1.

The first external circuit board FPC1 and the second area 32 in the bended state may be supported by a spacer 42 having a smoothly rounded end. The spacer 42 is arranged between the curved second area 32 and a flat area of the flexible substrate SUB1. The second area 32 may not be fixed to the first external circuit board FPC1 but may be directly fixed to the spacer 42. When the second area 32 is fixed to the first external circuit board FPC1 or the spacer 42, even if a crack is formed in the first side E1, the crack is less likely to be spread.

According to the display device DSP of the first embodiment having the above-described structure, the second area 32 which is longer than the first area 31 is formed between the first area 31 and the first side E1. The second area 32 may be referred to as an additional area which is added to separate the first mounting terminals T1 from the first side E1. According to the first embodiment, even if a crack is formed in the first side E1, the impact of the crack can be excluded, and the connection reliability of the first external circuit board FPC1 mounted on the first mounting terminals T1 in the first area 31 can be ensured.

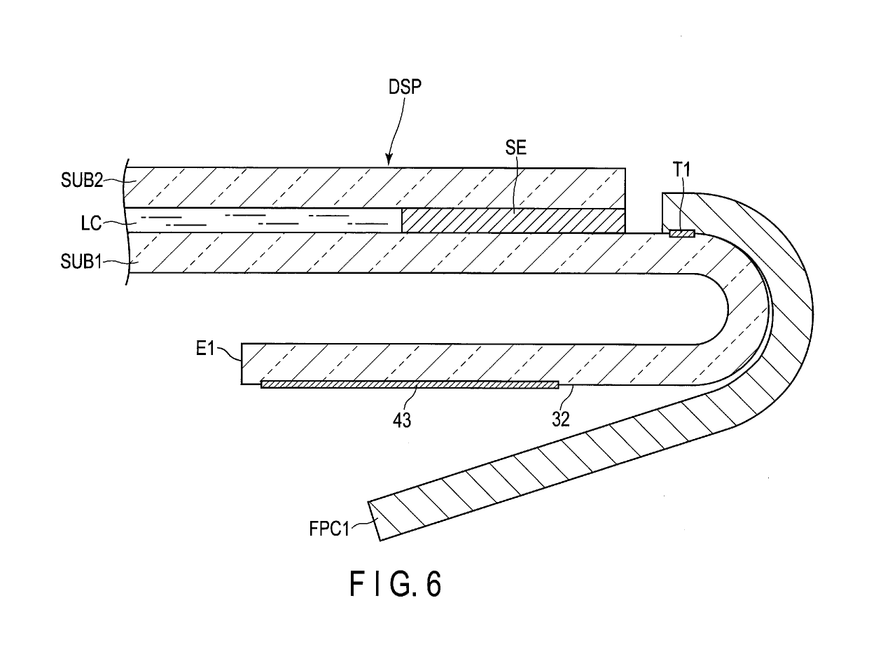

Next, the display devices DSP according to the second and fifth embodiments will be described with reference to FIGS. 6 to 11. A structure having the same or similar function as that of the structure of the first embodiment will be denoted by the same reference number and the corresponding description of the first embodiment will be referred, and description thereof will be omitted. Further, the other structure is the same as that of the first embodiment.

### Second Embodiment

The second embodiment differs from the first embodiment in that the second area 32 has an additional function. FIG. 6 is a sectional view showing an example of the display device DSP of the second embodiment. In the example shown in FIG. 6, a circuit 43 is formed in the second area 32. An example of the circuit 43 is a selector circuit of a touch panel.

The touch panel includes, for example, a touch sensor formed of a transmitter electrode and a receiver electrode which are opposed to each other, and a selector circuit which drives this touch sensor. Electrostatic capacitance is formed between the transmitter electrode and the receiver electrode. The selector circuit switches areas of the touch sensor in a time-sharing manner for sensing. The common electrode CE of the flexible substrate SUB1 may have the function of the transmitter electrode. In a case where the common electrode CE also functions as the transmitter electrode, the selector circuit switches the common electrode CE between an image display mode and a sensing mode in a time-sharing manner.

The conventional non-display area NDA without the second area 32 is called a frame area. As a result of the progress of narrowing of the frame of the display device DSP, the space of the frame area is tight. According to the second embodiment, a part of the circuit formed in the frame area or the first external circuit board FPC1 can be moved to the second area 32 having a wide space. As a result, the layout flexibility in circuit design increases. Therefore, the frame area can be further narrowed, and the connection reliability can be improved by reducing the mounting density of the frame area.

FIG. 7 is a sectional view showing another example of the second embodiment. In the example shown in FIG. 7, an electronic component 44 is mounted on the second area 32. The electronic component 44 is, for example, a light emitting element such as an LED or an organic EL. A light guide 45 which converts point light to planar light, etc., may be provided together with the light emitting element. Light emitted from the light emitting element enters from an end surface of the light guide 45. The light guide 45 emits light entering from the end surface to the rear surface of the first substrate SUB1. The light emitting element and the light guide 45 are examples of the illuminator which emits light to the rear surface of the display panel PNL.

In general, the backlight unit BL, which is another example of the illuminator, is connected to the first external circuit board FPC1 via another external circuit board which is prepared separately (hereinafter referred to as an illumination wiring line) and receives a control signal and power from the first external circuit board FPC1. The illumination wiring line is mounted on a mounting terminal for the illumination wiring line formed in the first external circuit board FPC1.

On the other hand, according to the second embodiment, the second area 32 which is a part of the drive area 3 is already connected to the first external circuit board FPC1 via the first mounting terminals T1. The control signal and power from the first external circuit board FPC1 are supplied to the electronic component 44 not via the illumination wiring line but via the first mounting terminals T1. Therefore, it is unnecessary to purchase the illumination wiring line or form the mounting terminal for the illumination wiring line in the first external circuit board FPC1. According to the second embodiment, the number of components can be reduced, and the manufacturing cost of the display device DSP can be reduced, accordingly. Further, the layout flexibility in the first external circuit board FPC1 can be improved by omitting the mounting terminal for the illumination wiring line formed in the first external circuit board FPC1.

The circuit 43 and the electronic component 44 are not limited to the previously-described examples. For example, each of the circuit 43 and the electronic component 44 may be a short-range communication antenna for contactless power supply, a fingerprint sensor of an ultrasonic type, etc., or an RGB switch circuit which integrates wiring lines of three colors and supplies a video signal which is used color by color in a time-sharing manner. Furthermore, various circuits, various components, and combinations thereof can be considered as the circuit 43 and the electronic component 44.

### Third Embodiment

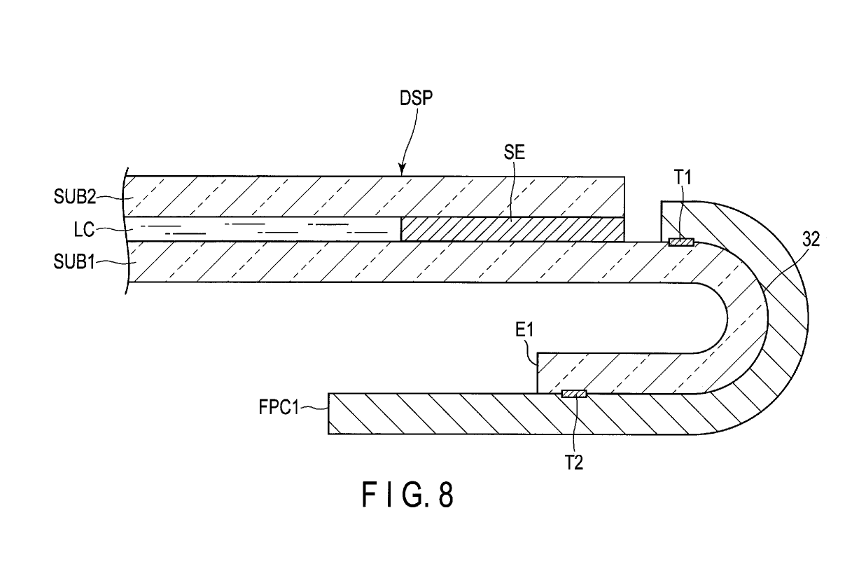

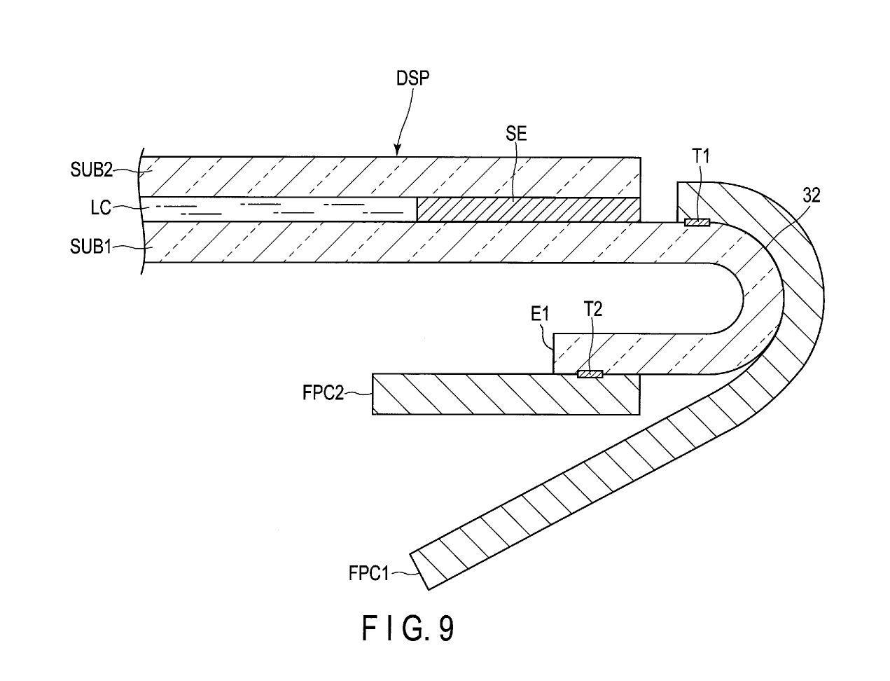

FIGS. 8 and 9 are sectional views showing the third embodiment. The third embodiment differs from the first embodiment in that at least one second mounting terminal T2 is formed in the second area 32. FIG. 8 shows an example of mounting the first external circuit board FPC1 on both the first mounting terminals T1 and the second mounting terminal T2, and FIG. 9 shows an example of mounting a second external circuit board FPC2 different from the first external circuit board FPC1 on the second mounting terminal T2.

According to the third embodiment, a part of the first mounting terminals T1 formed in the first area 31 can be moved to the second area 32, and therefore the layout flexibility of the mounting terminals in the drive area 3 can be improved. In the first area 31, since the space is widened, the size of the first mounting terminals T1 may be increased by reducing the mounting density of the first mounting terminals T1. As the size of the first terminals T1 increases, the contact area with the first external circuit board FPC1 increases, and the connection reliability improves.

### Fourth Embodiment

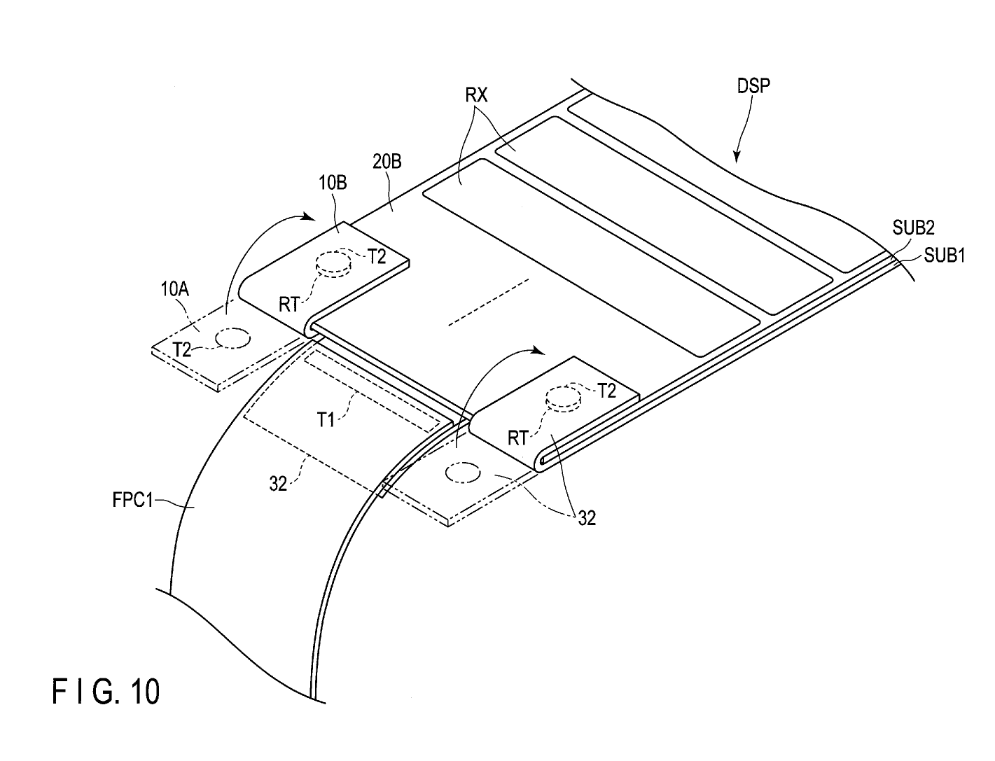

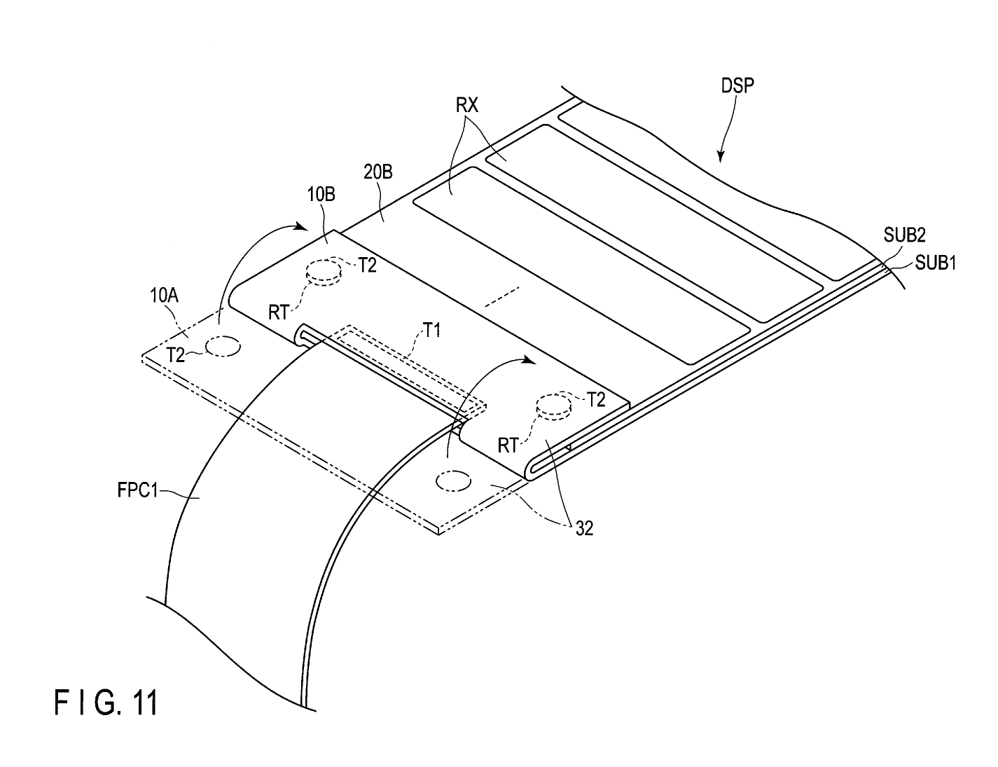

The fourth embodiment differs from the first embodiment in that the second area 32 is not bended toward the rear surface side of the display panel PNL but is bended toward the display surface side of the display panel PNL. FIG. 10 is a perspective view showing an example of the display device DSP of the fourth embodiment. FIG. 11 is a perspective view showing another example of the display device DSP of the fourth embodiment.

In the examples shown in FIGS. 10 and 11, a receiver terminal RX and an electrode terminal RT which is electrically connected to the receiver electrode RX are arranged on the fourth surface 20B of the counter-substrate SUB2. The receiver electrode RX is an example of a touch panel electrode. Alternatively, a transmitter electrode may be arranged on the fourth surface 20B or both the transmitter electrode and the receiver electrode RX may be arranged on the fourth surface 20B.

As shown in FIGS. 10 and 11, in the fourth embodiment, the second area 32 has two slits extending in the second direction Y and is divided into three areas. The area located in the middle is an area corresponding to the first mounting terminals T1, and the area located on the right and the area located on the left are areas having the second mounting terminals T2. The second mounting terminals T2 are electrically connected to the first external circuit board FPC1 via wiring lines which are not shown in the drawings.

In FIG. 10, the second area 32 is partially or second mounting terminal T2 formed in the second area 32 is electrically or mechanically connected to the electrode terminal RT by an anisotropic conductive film, etc. That is, the receiver electrode RX is electrically connected to the first external circuit board FPC1 via the electrode terminal RT and the second mounting terminal T2. Therefore, according to the fourth embodiment, it is no longer necessary to prepare another external circuit board which electrically connects the touch panel electrode to the display panel PNL (hereinafter referred to as a touch panel wiring substrate) separately. Consequently, the number of components can be reduced, and the manufacturing cost of the display device DSP can be reduced, accordingly.

FIG. 11 shows a modification of the fourth embodiment. A difference between FIG. 10 and FIG. 11 is that an opening is provided at a position corresponding to the first mounting terminals T1 in the second area 32. In a structure in which the first external circuit board FPC1 passes through the opening, the same advantage as that of the structure of FIG. 10 can be obtained. As the method of forming the opening, for example, during or after the process of manufacturing the flexible substrate SUB1, laser light is applied and the material (for example, polyimide resin) of the flexible substrate SUB1 is removed.

### Fifth Embodiment

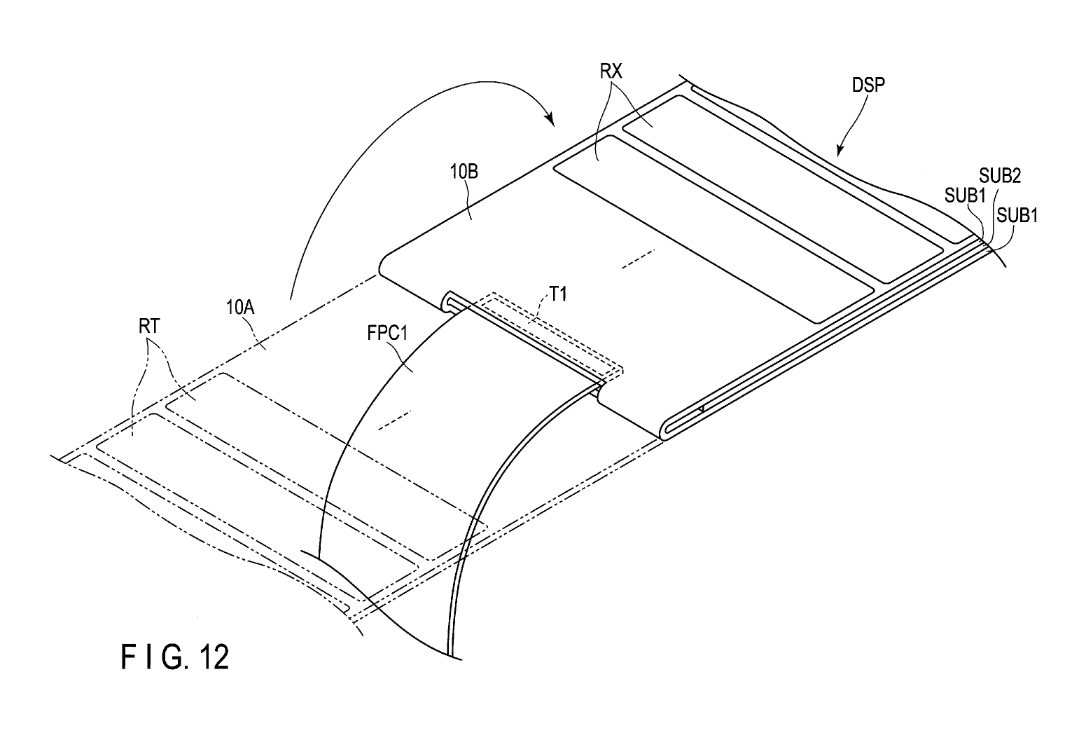

FIG. 12 is a perspective view showing the fifth embodiment. The fifth embodiment differs from the fourth embodiment in that not a touch panel wiring line but a touch panel electrode is formed in the second area 32. The touch panel electrode may include both a transmitter electrode and a receiver electrode or may be one of a transmitter electrode and a receiver electrode.

A hybrid-type touch panel including a transmitter electrode arranged in an in-cell manner on the first surface 10A of the flexible substrate SUB1 and a receiver electrode arranged in an on-cell manner on the fourth surface 20B of the counter-substrate SUB2 is known. If the counter-substrate SUB2 is a glass base, the receiver electrode RX can be directly formed on the fourth surface 20B by means of sputtering, etc.

However, if the counter-substrate SUB2 is a resin base, a transparent conductive film cannot be formed by sputtering on the fourth surface 20B. In the case of forming a hybrid-type or on-cell type touch panel in the flexible display device DSP, a touch panel electrode is formed into a sheet beforehand and is attached to the counter-substrate SUB2.

In contrast to a structure in which a touch panel electrode is externally attached and is connected to the display panel PNL by a touch panel wiring line, according to the fifth embodiment shown in FIG. 12, a touch panel electrode (for example, the receiver electrode RX) is formed in the second area 32, and therefore a sheet-like touch panel electrode will not be required separately. Similarly to the fourth embodiment, a touch panel wiring line which connects a touch panel electrode to the display panel PNL will not be required separately. According to the fifth embodiment, the number of components can be reduced, and the manufacturing cost of the display device DSP can be reduced, accordingly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiments, the electro-optical layer is not limited to a liquid crystal layer. The electro-optical layer may be an organic EL, an electrophoretic element, etc., stated in the beginning. For example, the drive area 3 may not be provided only in the non-display area NDA1 of the flexible substrate SUB1 but may be provided in both the non-display area NDA1 and the non-display area NDA3. For example, the timings of removing the first and second glass substrates are not limited to the examples shown in FIG. 3. The first and second glass substrates may be removed at timings earlier than the examples shown in FIG. 3 or the first glass substrate may be removed before the second glass substrate. To improve the handling during manufacturing processes by providing rigidity to a flexible base (10, 20) removed from a glass substrate, a temporary protective film which is used in manufacturing processes but will not be used as a part of a finished product may be attached to the flexible base.

What is claimed is:

1. A display device comprising:
a flexible substrate having an end area which includes a side and a drive area; and
a plurality of first mounting terminals which are arranged in a first direction and on which a first external circuit board is mounted, wherein
the drive area has a first area including the first mounting terminals, and a second area located between the first area and the side,
the first mounting terminals extend in a second direction intersecting the first direction, and
the second area which does not include the first mounting terminals is longer than the first area which includes the first mounting terminals in the second direction.

2. The display device of claim 1, further comprising a circuit arranged in the second area.

3. The display device of claim 1, further comprising a plurality of second mounting terminals arranged in the second area, wherein
a second external circuit board different from the first external circuit board is mounted on the second mounting terminals.

4. The display device of claim 3, further comprising a counter-substrate opposed to the flexible substrate, wherein
the counter-substrate includes touch panel electrode and electrode terminal electrically connected to the touch panel electrode, and
the electrode terminal is electrically connected to the second mounting terminal.

5. The display device of claim 1, further comprising a light emitting element arranged in the second area, wherein
the light emitting element is connected to the first external circuit board via the first mounting terminals.

6. The display device of claim 1, wherein the second area is fixed to the first external circuit board mounted on the first mounting terminals.

7. The display device of claim 1, further comprising an illuminator and a liquid crystal layer which selectively transmits light emitted from the illuminator, wherein
the flexible substrate is a transparent polyimide substrate between the illuminator and the liquid crystal layer, and
the light emitted from the illuminator passes through the flexible substrate.

8. The display device of claim 7, wherein a haze value of the flexible substrate is 10% or less.

9. The display device of claim 1, wherein the drive area further includes a third area between the first area and a display area in which an image is displayed, wherein
wiring line connected to the first mounting terminal is arranged in the third area.

10. The display device of claim 9, wherein the second area is longer than the third area in the second direction.

11. The display device of claim 1, wherein
the second area is bended toward a rear surface opposite to a display surface, and
a spacer is arranged between the bended second area and a flat area of the flexible substrate.

12. The display device of claim 5, further comprising a light guide to which light is emitted from the light emitting element, wherein
the light guide emits the light emitted from the light emitting element to a rear surface of the flexible substrate.

13. The display device of claim 1, further comprising a plurality of second mounting terminals arranged in the second area, wherein
the first external circuit board is mounted on the first mounting terminals and the second mounting terminals.

14. The display device of claim 2, further comprising a light emitting element arranged in the second area, wherein
the light emitting element is connected to the first external circuit board via the first mounting terminals.

15. The display device of claim 3, further comprising a light emitting element arranged in the second area, wherein
the light emitting element is connected to the first external circuit board via the first mounting terminals.

16. The display device of claim 4, further comprising a light emitting element arranged in the second area, wherein
the light emitting element is connected to the first external circuit board via the first mounting terminals.

17. The display device of claim 2, wherein the second area is fixed to the first external circuit board mounted on the first mounting terminals.

18. The display device of claim 3, wherein the second area is fixed to the first external circuit board mounted on the first mounting terminals.

19. The display device of claim 4, wherein the second area is fixed to the first external circuit board mounted on the first mounting terminals.

20. The display device of claim 5, wherein the second area is fixed to the first external circuit board mounted on the first mounting terminals.
